(19) United States
(12) Patent Application Publication
(10) Pub. No.: US 2005/0082117 A1
(43) Pub. Date: Apr. 21, 2005

(54) Swimming pool ladder

(76) Inventor: Jaime Morral Gispert, Polinya (ES)

Correspondence Address: JORDAN AND HAMBURG LLP, 122 EAST 42ND STREET, SUITE 4000, NEW YORK, NY, 10168, US

(21) Appl. No.: 10/915,284

(22) Filed: Aug. 10, 2004

(30) Foreign Application Priority Data
Oct. 15, 2003 (ES) U200302327

(51) Int. Cl. E06C 9/00

(52) U.S. Cl. 182/93

(57) ABSTRACT

A swimming pool ladder comprises two tubular side members having several rungs fixed to them. each side member is formed by two portions, i.e. an upper one and a lower one, the portions being adapted to be fitted and joined together by using the very means being used to fix the rungs to the side members. The lower end of the upper portion of the side member is fitted onto the smaller diameter upper end of the lower portion of the side member, the two ends being provided with transverse holes for the passage of the bolts, the bolts fixing the rungs to the side members and joining together the upper and lower portions of the side members.

### BACKGROUND OF THE INVENTION

Several models of swimming pool ladders are known and comprise among them those being made up by two tubular side members having fixed to them several rungs and being upwardly extended thereby forming respective handrails.

These types of ladders are usually of the dismountable type, the rungs being attached to the side members by means of bolts.

Given the length of these ladders, which can even be more than two meters long, they require a lot of space both for their storage and for their transportation, cartons of large dimensions having to be used in order to pack them.

This represents a problem for the makers, the problem becoming even more serious in the case of the members of the public purchasing the ladders since because of their dimensions they cannot be transported in the trunk of the motorcar.

### BRIEF SUMMARY OF THE INVENTION

These problems are now being solved in a practical and economic way with the ladder being the object of this invention, the ladder being made up by two side members being each formed by two portions, i.e. an upper one and a lower one, a particular feature lying in the fact that the two portions forming each side member are joined together by using the very means being used to fix the rungs to the side members.

With this makeup the whole set of components forming the ladder has a length only slightly surpassing half the length of the assembled ladder, this bringing about a sensible reduction of the space being needed for storing it, and also of the size of the packing case, this latter besides having a lower cost.

These and other features of the invention will be best made apparent by the following detailed description whose understanding will be made easier by the accompanying drawings showing a practical embodiment being cited only by way of example and not limiting the scope of the present invention.

### DESCRIPTION OF THE DRAWINGS

FIG. 1 is an exploded perspective view the swimming pool ladder;

FIG. 2 is a side elevation of the ladder once assembled; and

FIG. 3 is a plan-view of the ladder. DETAILED DESCRIPTION OF THE PREFERRED EMBODIMENTS.

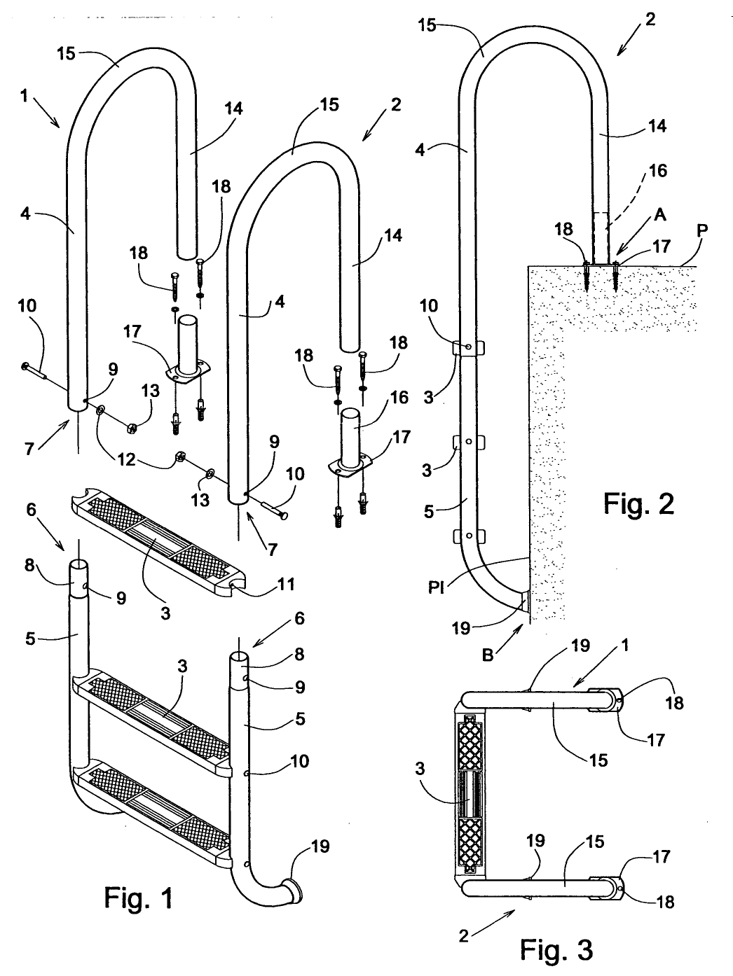

According to the drawings the ladder being represented in them is of the so-called wall type having one A of its ends fixed onto the swimming pool P near its edge whereas its other end B abuts against the inner wall PI of the swimming pool.

This ladder comprises two tubular side members 1 and 2 having several rungs 3 fixed to them, each side member being formed by two portions, i.e. an upper one 4 and a lower one 5. These two portions are fitted together by fitting the upper end 6 of the lower portion 5 into the open lower end 7 of the upper portion 4 of the side members, the upper end 6 for such a purpose having the end length 8 of smaller diameter.

These two portions 4 and 5 of the side members are joined together by using the very means being used to fix the rungs 3 to said side members 1 and 2.

The ends 6 and 7 of the portions 4 and 5 are for such a purpose provided with transverse holes 9 for the passage of bolts 10 which fix the rungs 3 and for this latter purpose extend through holes 11 of end faces of the rungs 3, a nut 12 being with the intermediary of a respective washer 13 threadingly engaged with each of the bolts.

The side members 1 and 2 are upwardly extended and thereby assume an arcuate shape extending downwards and thus determining a downwardly extending portion 14 whose end A serves to fix the side members onto the swimming pool P, each of the arcuate lengths forming a handrail 15 making up a respective handrailing.

In the embodiment being shown the ladder is fixed to the swimming pool through the intermediary of tubular brackets 16 being attached to a base 17 being fixed by means of screws 18 onto the swimming pool P, the lower ends of the portions 14 of the side members being fitted onto the tubular brackets 16.

It is understood that this fixing means can be of any other description, the other fixing means also being provided for the case where the ladder to be installed is of the articulated type and can be lowered onto the swimming pool edge.

Respective end caps 19 are fitted to the lower end B of the lower portion 5 of each of the side members, the ends B abutting against the inner wall PI of the swimming pool through the intermediary of said end caps.

The invention can within its essentiality be put into practice in other embodiments only in detail differing from that having been set forth above only by way of example.

1. A swimming pool ladder comprising two tubular side members having several rungs fixed to them, each side member being formed by an upper portion and a lower portion, said portions being adapted to be fitted and joined together.

2. A swimming pool ladder as per according to claim 1, characterized in that further comprising fixing means fixing at least one of the rungs to the side members and, at the same time, joining together the two portions of each side member.

3. A swimming pool ladder according to claim 1 or 2, wherein a lower end of the upper portion of each side member is fitted onto a smaller diameter upper end of the lower portion of the side member, said fixing means comprising bolts and transverse holes provided in said two ends for the passage of the bolts being also apt to fix.
